(19) United States
(12) Patent Application Publication
(10) Pub. No.: US 2005/0151439 A1
(43) Pub. Date: Jul. 14, 2005

(54) Traveling wave machine

(76) Inventors: Andreas Grundl, Munchen (DE); Bernhard Hoffmann, Starnberg (DE)

Correspondence Address: Tarolli Sundheim;Covell & Tummino, Suite 1111, 526 Superior Avenue, Cleveland, OH, 44114-1400, US

(21) Appl. No.: 10/490,324

(22) PCT Filed: Sep. 4, 2002
(86) PCT No.: PCT/EP02/09908

(30) Foreign Application Priority Data
Sep. 4, 2001 (DE) 101 43 217.8

(51) Int. Cl. H02K 3/04; H02K 17/00

(52) U.S. Cl. 310/201

(57) ABSTRACT

A travelling field machine with a stator and a rotor, each of which comprising at least one stator coil or one rotor coil, respectively, with the stator or the rotor, respectively, comprising a soft magnetic iron body with a stator or rotor back, respectively, in which spaced grooves are formed, generating teeth and the stator or rotor coils, respectively, comprising conductor bars arranged in the grooves of the stator or the rotor, respectively, and end windings arranged at the end faces of the stator or the rotor, respectively, and with the stator or rotor coils, respectively, in the area of the end windings being angled at least partially and essentially transverse to the bottom of the grooves and protruding from the bottom of the grooves at least partially in the direction of the stator or rotor backs, respectively.

### FIELD OF THE INVENTION

The present invention relates to a travelling field machine. The invention relates, in particular, to a travelling field machine with a stator and a rotor, each of which comprising at least one stator coil or one rotor coil, respectively, with the stator or the rotor, respectively, comprising a soft magnetic iron body with a stator or rotor back, respectively, in which spaced grooves are formed, generating teeth.

### DEFINITION OF TERMS

The term “travelling field machines”, i.e. asynchronous, synchronous, reluctance machines etc. covers motors as well as generators, whereby it is of no significance in particular for the invention whether such a machine is designed as a rotating machine or, for example, as a linear motor. Moreover, the invention may be applied both to internal rotor machines and external rotor machines.

### BACKGROUND OF THE INVENTION

In the reduction of the volume of highly efficient electrical machines the form of construction and the arrangement of the conductors play a decisive role. Conductors with a minimum length in the winding overhangs at a high utilisation of the space reduce the ohmic losses and increase the power density.

Due to the fact that the ohmic losses in the control and in the winding are proportional to the current to be connected, a certain conductor length must be provided in the magnetic field in order to generate an induced back voltage corresponding to the desired high control voltage in a conductor arrangement of a resistance as low as possible.

Conventional electrical machines in their majority are wound with continuous wires—mostly with round cross-section. Though a thin flexible wire may easily be placed into the grooves, it has the disadvantage of a poor space utilisation in the grooves and winding overhangs. Wires with round cross-section cannot fully utilise the cross-sectional area of the groove.

Due to the fact that the wires must be insulated against one another and generally have a circular cross-section, the filling factor of the grooves (total wire cross-sectional area/groove sectional area) amounts to approx. 35% to 40%. Because it cannot be reliably predicted for such wound wire coils which windings of the wound wire coils come to lie adjacent to one another, the insulation layer must have at least the dielectric strength of the maximum nominal voltage applied to the winding. With a low number of wires per groove, in particular, or if the conductor cross-section is relatively large compared to the groove cross-section, the space utilisation in the grooves decreases. Conductors with a cross-section which is adapted to the groove cross-section can be continuously wound only under very high expenses.

When winding or inserting, respectively, both wires and pre-formed coils, bending radii must be adhered to in the deformation of the insulated conductors. With decreasing bending radii the risk is increasing that the insulation layers of minimum thickness which are applied already before the deformation, are damaged or functionally affected. The space in the winding overhangs can therefore be utilised insufficiently only, and the magnetically non-effective conductor length, the total weight, the required space, and the ohmic losses increase.

### STATE OF THE ART

From DE 38 03 752 A1 a stator for a three-phase generator is known, whose stator core assembly comprises grooves in which stator windings are arranged. The stator winding portions within the grooves have a rectangular cross-section and the stator winding portions forming the coil ends outside the grooves have a circular cross-section. The stator winding portions with the circular cross-section are formed by hollow cylindrical conductors, while the stator winding portions with the rectangular cross-section are formed by compression of the hollow cylindrical conductor.

From GB 1 329 205 it is known to manufacture the windings as cast bodies wherein the end portions (protruding from the grooves) have a larger cross-section than the conductor portions within the grooves.

From DE 197 36 645 C2 it is known to establish the ratio between the thickness of the stator or the rotor coil, respectively, in the area of the coil end and the thickness of the stator or the rotor coil, respectively, in the area of the groove in such a manner that it corresponds to the product of the number of phases of the travelling field machine and the number of holes of each coil. This ensures that the coils in the end area have not greater width in the radial direction than the depth of the grooves in the radial direction. In this manner, all windings in the end area can be placed adjacent to one another in the radial direction without protruding beyond the grooves or the backs of the rotor or stator in the radial direction. The end portions are crimped parallel to the groove longitudinal axis relative to the groove portions of the windings and routed together per phase at a minimum distance above the grooves.

From EP 1 039 616 A2 a travelling field machine is known whose stator carries a stator coil. The stator has a soft magnetic iron body with a stator back in which spaced grooves are formed, generating teeth. The stator coils have conductor bars arranged in the grooves and end windings arranged at the end faces of the stator, which connect the conductor bars. The end windings of the stator coils are arranged transverse to the groove bottom and protrude the groove bottom towards the stator back. The stator portions in the end face area of the stator protrude beyond it in a radial inward direction. The end windings and the conductor bars are brazed together by means of studs.

### PROBLEM ON WHICH THE INVENTION IS BASED

The above explained known arrangements suffer from the drawback that they meet the requirements with respect to power density and reliability only partially, as are specified for several applications.

The design of the coil ends is a critical factor for the efficiency of the electrical machine, with the known constructions being not optimised for highly efficient machines concerning the requirements for large-scale production.

The joints of the conductor bars in the grooves with the end windings in the coil ends, for example, are an essential factor for the reliability of the respective electrical machine. This is all the more true since the spatially very restricted conditions in the area of the winding overhangs exclude a number of known joining techniques.

All known concepts have in common that with a sufficiently compact design the reliability for a large-scale application is not achieved. Moreover, the known approaches are very expensive in the manufacture.

### INVENTIVE SOLUTION

For the solution of these problems the invention teaches a travelling field machine of the above mentioned type with a stator and a rotor, each of which comprising at least one stator coil or one rotor coil, respectively, with the stator or the rotor, respectively, comprising a soft magnetic iron body with a stator or rotor back, respectively, in which spaced grooves are formed, generating teeth and the stator or rotor coils, respectively, comprising conductor bars arranged in the grooves of the stator or the rotor, respectively, and end windings arranged at the end faces of the stator or the rotor, respectively, and with the stator or rotor coils, respectively, in the area of the end windings being angled at least partially and essentially transverse to the bottom of the grooves and protruding from the bottom of the grooves at least partially in the direction of the stator or rotor backs, respectively. With this arrangement the end windings according to the invention have an effective thickness essentially transverse to an air gap between the stator and the rotor, which meets the following condition:
LD*n+RT*a=SD*n*PZ*LZ
wherein:
LD thickness of one of the conductor bars;
SD thickness of the end winding;
NT depth of the groove;
RT depth of the back;
a a safety factor (0 . . . 1);
n number of conductor bars in the direction of the groove depth NT
LZ number of holes of the coils; and
PZ number of phases of the travelling field machine.

This design permits a maximum utilisation of the available space (both in the axial and the radial, or lateral, respectively, direction) and at the same time a power optimisation of the electrical machine with a very high reliability in operation and low manufacturing costs.

### EMBODIMENTS AND DEVELOPMENTS OF THE INVENTION

The end windings with both of their end portions are preferably connected with the ends of the conductor bars by means of offset portions. The length of the offset portions together with the thickness of the end windings determines the dimension by which the winding overhangs protrude beyond the back of the rotor or stator.

The offset portions at both end areas of the end windings may have different lengths to the respective ends of the conductor bars and/or may be formed with different angles. It is thereby possible to arrange the end windings with a certain dimension by which the winding overhangs protrude beyond the back of the rotor or stator, according to the given number of phases and holes of the electrical machine.

The safety factor (a) ranges from 0.05 to 0.95, preferably from 0.2 to 0.8.

A better spatial utilisation can be achieved in that at least on one of the two end faces of the stator the end windings are broadened not only in the direction of the stator back but also in the direction of the air gap between the stator and the rotor. In this case, another factor is to be included on the right side into the above equation, which accounts for this value.

The conductor bars at their respective ends have a joint area which matches corresponding portions at the end windings for a mechanical and electrical connection. The design of this mechanical and electrical connection may have various forms. A first embodiment of the invention has a slot at both end faces of the conductor bars, into which one end each of a end winding is inserted and electrically and mechanically connected with the conductor bar. Alternatively, a connecting lug may be formed at one or both ends of a conductor bar, which is electrically and mechanically connected with the corresponding portion of the end winding. In other words, joint areas are formed at the ends of the conductor bars by end face recesses or tapers, into which or at which, respectively, the corresponding portions of the end windings are inserted and contacted.

In a preferred embodiment of the invention in the form of a rotating machine, the grooves taper or expand towards an air gap between the stator and the rotor, and the conductor bars arranged in the grooves have a width which is at least partially adapted to the groove width, depending on their position in the groove. This offers the maximum utilisation of the available groove space.

In an embodiment of the invention each stator or rotor winding, respectively, is constructed of conductor bars with an essentially rectangular cross-section in the grooves and end windings forming winding overhangs, with the conductor bars being integrally and electrically connected at their ends with the end windings in that each of the end windings comprises an essentially U-shaped end portion with two opposite legs whose inner surfaces facing each other are joined with corresponding lateral surfaces of an end portion of one of the conductor bars.

This solution permits a particularly reliable and economical manufacture, also in large-scale operation, of the stator windings with excellent electrical and mechanical properties.

The joint between the end portion of the conductor bar and the end portion of the end winding may—regardless of the design of the end portion of the conductor bar and the end portion of the end winding—comprise a layer of brazing solder, preferably silver brazing solder, tin brazing solder, or the like, or the joint between the end portion of the conductor bar and the end portion of the end winding has a layer of high-temperature soft solder, preferably with a melting point of at least approx. 380 degrees Celsius.

In order to avoid the generation of an expansion in the area of the winding overhangs (with the associated space problem), the end portion of the conductor bar is preferably tapered by at least approximately the wall thickness of the essentially U-shaped end portion of the end winding. This has to be done at all those side surfaces where the end portion of the end winding is in engagement with the end portion of the conductor bar.

If the end portion of the end winding engages and comes into contact with only two (e.g. mutually opposite) lateral surfaces of the end portion of the conductor bar and forms (an integral) joint, the packing density of the winding layers in the winding overhang can be kept equal to that in the winding groove.

Preferably each of the legs opposite one another comprises a projection at its inner surface facing the end potion of the conductor bar, which contacts the corresponding lateral surfaces of the end portion of the conductor bar. This facilitates a defined sequence of the material integration in the joining process.

The integral joining can particularly easily be effected by electric impulse welding. Alternatively, the end portions of the end windings may be integrally joined with the end portions of the conductor bar by laser welding.

In particular with multi-phase electrical machines it is necessary that the winding overhangs are laterally offset relative to each other. This can be realised most conveniently in that the end winding axially protrudes beyond the end portion of the conductor bar and is crimped.

The conductor bar and/or the end winding are preferably provided with a ceramic or enamel coating. For this purpose, it is advantageous to join the two parts to form essentially L-shaped components, to apply the ceramic or enamel coating prior to or following the joining step, to subsequently insert them layer by layer (from both end faces) into the grooves of the soft magnetic body, and then join them to form the respective windings.

The invention also relates to a method for manufacturing an electrical machine with a rotor or stator which comprises several grooves which are arranged distributed about its circumference, forming winding chambers for accommodating at least one rotor or stator winding, respectively, as previously defined, with the steps of: Inserting an essentially rectangular conductor bar into a winding chamber so that an end portion of the conductor bar protrudes at at least one end face of the rotor or stator, integral attachment of an end winding to the protruding end portion of the conductor bar by compression of the end winding and the protruding end portion of the conductor bar, and simultaneously with or subsequent to the compression an application of electrical contacts both to the conductor bar and the end winding, through which a predefined electrical power pulse flows which is sufficient for melting the material at the joint(s), with the sites at which the electrical contacts are applied to the conductor bar and the end winding being different from the sites of compression.

The sites at which the electrical contact electrodes are applied at the conductor bar and the end winding are different from the site of compression. Therefore, an adherence or melting of the contact electrodes with the parts to be joined is avoided.

The two opposite legs comprise the respective lateral surfaces of the end portion of the conductor bar and are urged against these.

According to the invention the power of the pulse is so determined that in the area of the joint essentially no heat is dissipated to the environment. This is achieved in particular in that the power is introduced into the parts to be joined in a time interval as short as possible. The melting process therefore takes place so rapidly that hardly any energy is dissipated to the environment prior to the termination of the joining process.

According to the invention the conductor cross-section outside the soft magnetic body adapts itself to the respective available space, whereby the conductor cross-section is enlarged in particular at the joints, in order to enable low transfer resistance values through large contact areas. Due to the improved space utilisation the efficiency or the power density of the machine is increased.

Further characteristics, properties, advantages, and possible modifications will become apparent for those with skill in the art from the following description in which reference is made to the accompanying drawing.

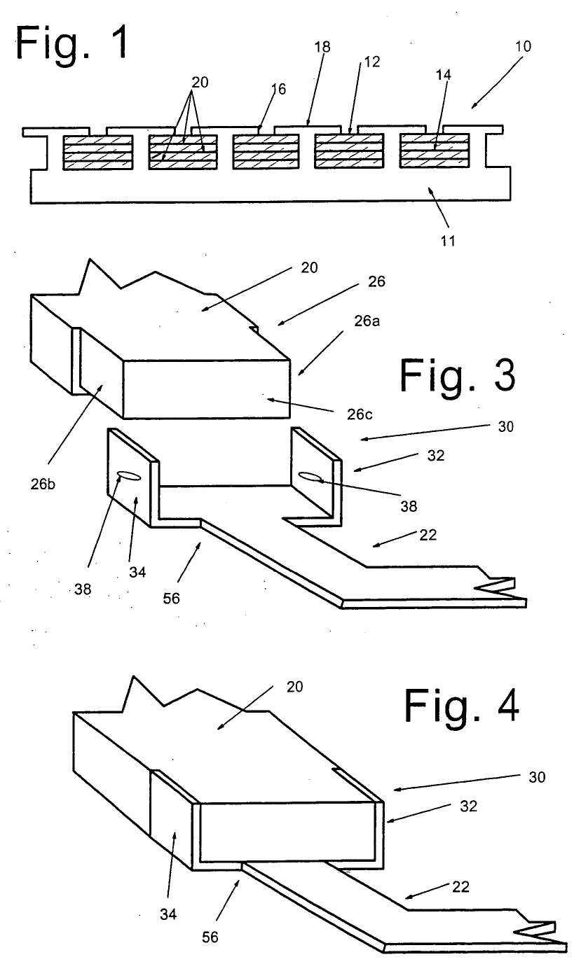

In FIG. 1 a development of a stator for an electric motor according to the invention is schematically illustrated in a plan view, with the stator windings sectioned.

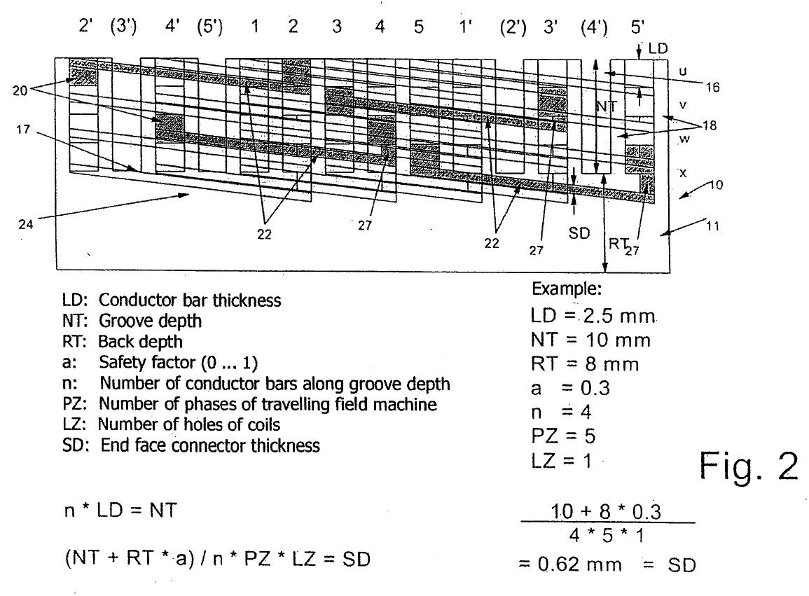

FIG. 2 schematically shows how the winding overhangs of an electrical motor as illustrated in FIG. 1 are arranged over the winding grooves and the stator back.

FIGS. 3 and 4 show in a perspective illustration how a conductor bar of a winding according to FIG. 1 is to be joined with an end winding forming the winding overhang.

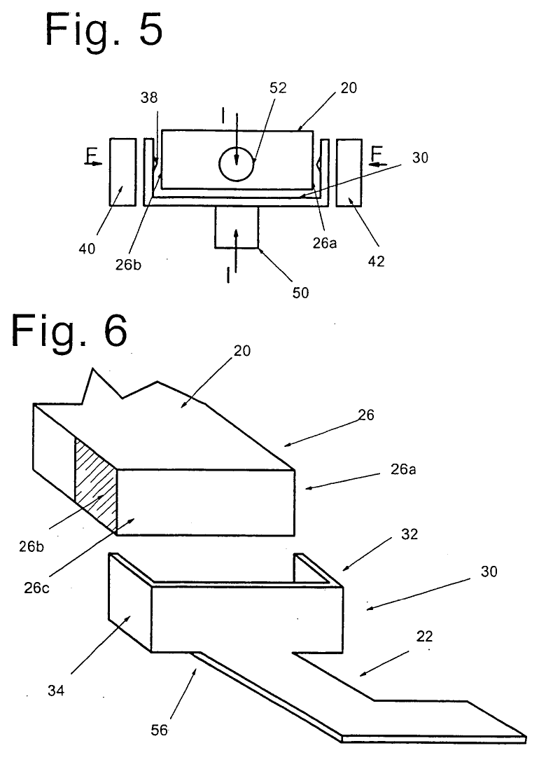

FIG. 5 depicts in a schematic plan view how the conductor bar and the end winding from FIGS. 3, 4 are compressed and fed an electrical pulse.

FIG. 6 shows a further alternative embodiment of an end winding, with a portion of an end winding in a schematic perspective illustration.

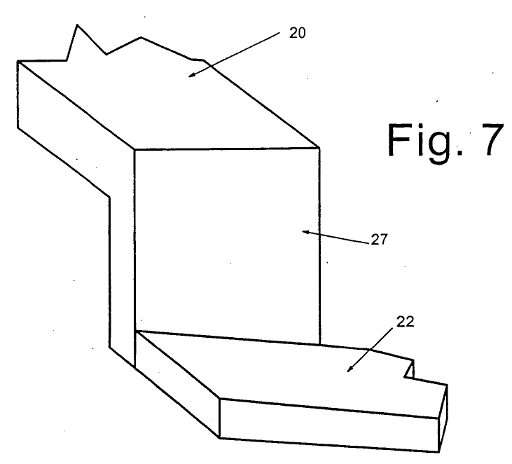

FIG. 7 shows a further alternative embodiment of an end winding, with a portion of an end winding in a schematic perspective illustration.

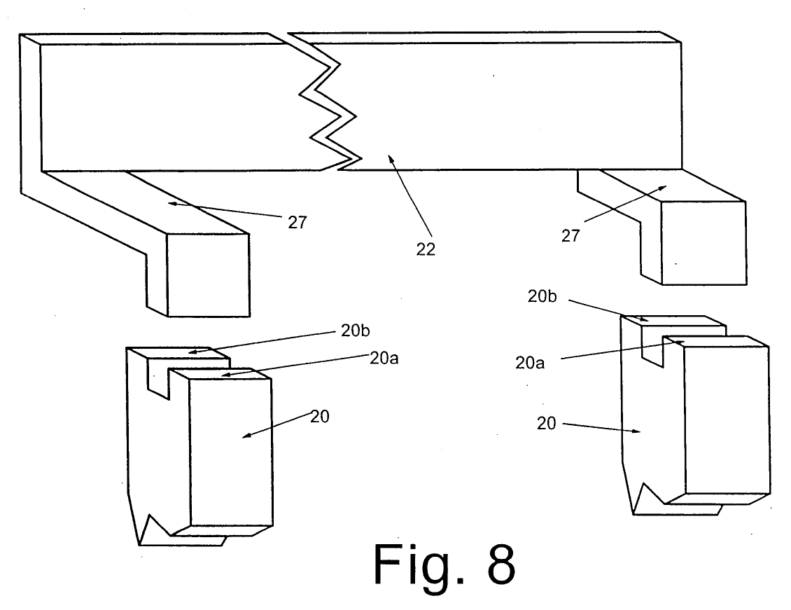

FIG. 8 shows still another alternative embodiment of an end winding, with a portion of an end winding in a schematic perspective illustration.

### DETAILED DESCRIPTION OF PREFERRED EMBODIMENTS

FIG. 1 is a plan view of a portion of a development of a stator 10 of an internal rotor machine (not shown in detail), with the invention being also applicable to external rotor machine. In the present embodiment, the stator 10 is built from stacked sheets (not shown in detail), but could also consist of iron particles which are pressed and sintered to the respective shape.

The stator 10 has grooves 12 arranged next to one another, by means of which the winding chambers for the respective stator coil windings 14 are formed. In the shown embodiment the winding chambers 12 have an essentially rectangular cross-section, with slots 16 in the side (not shown) facing towards the rotor. Thus, teeth 18 are formed between two slots 16 each.

Each stator coil 14 is formed by conductor bars 20 with an essentially rectangular cross-section, which are inserted in the winding chambers 12 and joined by end windings 22. The end windings 22 of all windings together form winding overhangs 24 (see FIG. 2).

FIG. 2 also shows a stator 10 of a travelling field machine with several stator coils. The stator 10 is a soft magnetic iron body with a stator back 11 at which spaced grooves 12 are formed, generating the teeth 18.

The stator coils 14 of the stator 10 are formed by conductor bars 20 arranged in the grooves 16 and end windings 22 arranged at the end faces of the stator 10 and joining the conductor bars 22. In the area of the end windings 22, the stator coils 14 are at least partially and essentially transverse to the bottom 17 of the grooves 16—relative to the longitudinal axis of the conductor bars 20—angled and partially protrude the bottom 17 of the grooves 16 towards the stator back 11. The end windings 22 have an essentially vertical orientation relative to the end face of the stator or the rotor, respectively.

The end windings 22 are also joined at one or both of their end portions with the ends 26 of the conductor bars 20 by means of offset portions 27 (see also FIG. 7 or 8) which are oriented transverse to the longitudinal axis of the conductor bars 20. The offset portions may be—as shown in FIG. 8—either part of the end winding 22 or—as shown in FIG. 8—part of the respective conductor bar 20.

As can be seen, in particular from FIG. 2 and FIG. 8, the offset portions 27 at the two end portions of the end windings 22 have different lengths to the respective ends 26 of the conductor bars 20 in order to obtain the respective relative position of the end winding in the winding overhang.

FIG. 2 depicts a winding overhang of a 5-phase/1-hole machine partly schematically, with each winding having 4 layers (u, v, w, x). For the sake of clarity, the two grooves 3′, 5′ at the left-hand side of the grooves 1, 2, 3, 4, 5, and the two grooves 2′, 4′ at the right-hand side of the grooves 1, 2, 3, 4, 5 are shown without conductor bars and end windings joined therewith. As can be seen, the winding overhang protrudes about 30% (a*RT) beyond the stator back 11. In particular with low-voltage machines (approx. 60 V operating voltage), the safety factor a can be set as high as 0.95. In the present computing example (see FIG. 2) the end winding 22 would have a thickness SD of 0.88 mm while the conductor bars have a thickness LD of 2.5 mm.

FIGS. 3, 4 show an embodiment for the design of the joint between the conductor bars 20 and the end windings 22. At their ends 26, the conductor bars 20 are integrally and electrically connected with the end windings 22. This is realised in that each of the end windings 22 comprises an essentially U-shaped end portion 30 with two opposite legs 32, 34 whose inner surfaces 32a, 34a facing each other are connected with corresponding lateral surfaces 26a, 26b of the end portion 26 of one of the conductor bars 20. FIGS. 3 and 4 show only the joint between one end of a conductor bar 20 and one half of an end winding 22 (otherwise with mirror-inverted structure).

For making this joint, the lateral surfaces 26a, 26b of the end portion 26 of the conductor bar 20 are provided with a layer of (silver) brazing solder in this embodiment.

As shown in the embodiment of FIG. 4 the end portion 26 of the conductor bar 20 is tapered by about the wall thickness of the essentially U-shaped end portion 30 of the end winding 22. It is thereby achieved that the spatial conditions in the area of the winding overhangs are not excessively restricted, or that the winding overhangs can be very compact so that the electromagnetically non-effective portion of the stator coils is relatively small. Due to the fact that the conductor bars and the end windings are joined via the two lateral surfaces or inner surfaces, respectively, a very large joint face and thus a mechanically and electrically very reliable joint is achieved.

At the inner surfaces of the opposite legs 32, 34, facing each other a projection 38 each in the shape of a cone is provided being formed by indentation from the outside of the legs 32, 34. Since the joint between the conductor bar and the end winding is made by electric impulse welding, as will be explained in more detail further below, this projection 38 provides for a reproducible electrical contacting and thus a defined melting process of the material to be joined in the welding operation.

In the manufacture of an electrical machine with the above described stator it is to be proceeded as follows according to a first embodiment:

First a stator (see FIG. 1) is provided which has the appropriate grooves. Into these grooves, the rectangular conductor bars are inserted which are dimensioned in such a manner that an end portion of the conductor bar each protrudes at both end faces of the stator. By using conductor bars whose shape is adapted to the shape of the grooves, the packing density (i.e. the filling factor) can be considerably increased compared to the conventional coil windings of round wire.

Subsequently, an end winding is joined with the protruding end portion of the conductor bar. For this purpose, the two opposite legs 32, 34 of the end portion 30 of the end winding 22 are pressed against the respective lateral surfaces 26a, 26b of the end portion 26 of the conductor bar 20 by means of two pressing jaws 40, 42 (see FIG. 5). Contrary to conventional tools in electric impulse welding, no current flows through these pressing jaws 40, 42. Rather these are pushed together merely by the forces F so that the two opposite legs 32, 34 of the end portion 30 of the end winding 22 are urged against the lateral surfaces 26a, 26b of the end portion 26 of the conductor bar 20. This causes the tips of the projections 38 to contact the lateral surfaces 26a, 26b each of the end portion 26. Concurrently with the compressive movement and the contact occurring between the projections 38 and the lateral surfaces 26a, 26b, electrical contacts are applied to the conductor bar and the end winding each, through which a predefined power pulse is flowing which is sufficient to melt the material at the joint(s).

Alternatively, conductor bars 20 can be joined at one of their ends with one end each of an end winding 22 so that essentially L-shaped structures are generated. These L-shaped structures are then inserted layer by layer from both end faces of the stator 10 into its grooves 12 and connected with the respective ends of the corresponding conductor bars or end windings, respectively, in the manner described above.

As is illustrated in FIG. 5, the sites where the electrical contacts are applied to the conductor bar and the end winding are different from the sites where the pressing jaws urge the two opposite legs 32, 34 of the end portion 30 of the end winding 22 against the respective lateral surfaces 26a, 26b of the end portion 26 of the conductor bar 20. In the shown embodiment, the electrical power pulse is introduced through two contact pistons 50, 52 which, in turn, are applied to the central web 56 (see FIGS. 3, 5) of the end winding, on the one hand, and to the end face 26c of the conductor bar, on the other hand. Needless to say that other sites—depending on the spatial conditions—can also be used for the introduction of the electric power pulse at the end winding or the conductor bar, respectively. This which is decisive is that the contact sites for the electrical power pulse are different from the sites where the end winding is joined (welded) with the conductor bar. The fact that no electric current flows through the sites of the introduction of force prevents the pressing jaws from adhering to one of the parts to be joined.

FIG. 6 shows a further embodiment of the end winding or the conductor bar, respectively, wherein the end winding 22 contacts the lateral surfaces 26a, 26b of the end portion of the conductor bar only with the two opposite legs 32, 34 of its end portion 30. This embodiment is advantageous in that the distance from the neighbouring conductor bar in the same winding chamber is not affected by the joint of the conductor bar with its respective end winding. The contact piston to be applied to the end winding may be applied to the centre portion 56 encompassing the end face 26c of the conductor bar, and the contact piston to be applied to the conductor bar may be applied to the opposite end of the conductor bar.

An essential advantage of this embodiment is that the end portion need not comprise any tapers for realising a space-saving joint between the conductor bars and the end windings in the critical orientations (in particular to neighbouring conductor bars).

FIG. 7 shows a further embodiment of the end winding and the conductor bar, wherein a tag as an offset portion 27 is integrally formed under an angle at the conductor bar. The end winding 22 is welded to the offset portion 27.

FIG. 8 shows a further embodiment of the end winding and the conductor bar, wherein the conductor bars 20 are integrally and electrically connected at their ends with the end windings, in that each of the conductor bars 20 comprises an essentially U-shaped end portion with two opposite legs 20a, 20b between which one end of the end winding 22 engages and is welded therewith. As can be seen, the offset portions 27 at the two end portions of the end winding 22 have different lengths to the respective ends of the conductors bars 20 and form an angle.

Principally, it is also possible to join the end portions of the end windings in plane contact with the end surfaces of the conductor bars (for example by welding).

The ratios of the individual parts and portions thereof shown in the figures and their material thicknesses are not to be construed as being limiting. Rather may individual dimensions deviate from the illustrated one. Moreover, it is understood that the embodiments shown in the figures have to be arranged about an axis of rotation or to be curved for rotating machines, i.e. internal or external rotor machines.

1. A travelling field machine with a stator (10) and a rotor, each of which comprising at least one stator coil (14) or one rotor coil, respectively, with
the stator (10) or the rotor, respectively, comprising a soft magnetic iron body with a stator back (11) or rotor back, respectively, in which spaced grooves (16) are formed, generating teeth (18), and
the stator coils (14) or rotor coils, respectively, comprising conductor bars (20) arranged in the grooves (16) of the stator (10) or the rotor, respectively, and end windings (22) arranged at the end faces of the stator (10) or the rotor, respectively, connecting the conductor bars (22), with
the stator coils (14) or rotor coils, respectively, in the area of the end windings (22) being angled at least partially and essentially transverse to the bottom of the grooves and protruding from the bottom of the grooves at least partially in the direction of the stator (11) or rotor backs, respectively, and with
the end windings (22) comprising an effective thickness SD essentially transverse to an air gap between the stator (10) and the rotor, which meets the condition:
LD*n+RT*a=SD*n*PZ*LZ
wherein:
LD thickness of one of the conductor bars;
SD thickness of the end winding;
NT depth of the groove;
RT depth of the back;
a a safety factor (0 . . . 1);
n number of conductor bars in the direction of the groove depth NT
LZ number of holes of the coils; and
PZ number of phases of the travelling field machine.

2. The travelling field machine according to claim 1, wherein
the end windings (22) are joined at both end portions with the ends (26) of the conductor bars (20) by means of offset portions (27).
the joint between the end portion of the conductor bar and the end portion of the end winding comprises a layer of high-temperature soft solder, preferably with a melting point of at least approx. 380 degrees Celsius.

3. The travelling field machine according to claim 2, wherein
the offset portions (27) at both end areas of the end windings (22) have different lengths to the respective ends of the conductor bars (20) and/are formed with different angles.

4. The travelling field machine according to claim 1, wherein
the safety factor (a) ranges from 0.05 to 0.95, preferably from 0.2 to 0.8.

5. The travelling field machine according to claim 1, wherein
the conductor bars (20) at their ends each comprise a joint area which matches corresponding portions at the end windings (22) for a mechanical and electrical connection.

6. The travelling field machine according to claim 5, wherein
the joint areas at the ends of the conductor bars (20) are formed by face end recesses or tpers into which or with which, respectively, the corresponding portions at the end windings (22) are inserted and welded.

7. The travelling field machine according to claim 1, wherein
the grooves taper or expand towards an air gap between the stator and the rotor, and
the conductor bars arranged in the grooves comprise a width which is at least partially adapted to the groove width, depending on their position in the groove.

8. The travelling field machine according to claim 1, wherein
each stator winding (14) or rotor winding, respectively, is constructed of conductor bars (20) with an essentially rectangular cross-section in the grooves (12) and end windings (22) forming winding overhangs, with the conductor bars (20) being integrally and electrically connected at their ends with the end windings (22) in that each of the end windings (22) comprises an essentially U-shaped end portion (30) with two opposite legs (32, 34) whose inner surfaces 32a, 34a) facing each other are connected with corresponding lateral surfaces (26a, 26b) of an end portion (26) of one of the conductor bars (20).

9. The travelling field machine according to claim 1, wherein
the joint between the end portion of the conductor bar and the end portion of the end winding comprises a layer of brazing solder, preferably silver brazing solder, tin brazing solder, or the like, or
the joint between the end portion of the conductor bar and the end portion of the end winding comprises a layer of high-temperature and solder, preferably with a melting point of at least approx. 380 degrees Celsius.

10. The travelling field machine according to claim 1, wherein
the end portion of the conductor bar is tapered by at least approximately the wall thickness of the essentially U-shaped end portion of the end winding.

11. The travelling field machine according to claim 1, wherein
each of the opposite legs comprises a projection at its inner surface facing towards the end portion of the conductor bar, which contacts the corresponding lateral surfaces of the end portion of the conductor bar.

12. The travelling field machine according to claim 1, wherein
the integral joint is carried out by electric impulse welding.

13. The travelling field machine according to claim 1, wherein
the end portions of the end windings are integrally joined with the end portions of the conductors bar by laser welding.

14. The travelling field machine according to claim 1, wherein
the end winding protrudes axially beyond the end portion of the conductor bar and is crimped.

15. The travelling field machine according to claim 1, wherein
the conductor bar and/or the end winding are provided with a ceramic or enamel coating.

16. A method for manufacturing an electrical machine with a rotor or stator which comprises several grooves which are arranged distributed about its circumference, forming winding chambers for accommodating at least one rotor or stator winding, respectively, as defined in the previous claims, with the steps of:
inserting an essentially rectangular conductor bar into a winding chamber so that an end portion of the conductor bar protrudes at at least one end face of the rotor or stator,
integral attachment of an end winding to the protruding end portion of the conductor bar
by compression of the end winding and the protruding end portion of the conductor bar, and
concurrently with or subsequent to the compression an application of electrical contacts both at the conductor bar and the end winding, through which a predefined electrical power pulse flows which is sufficient for melting the material at the joint(s), with
the sites at which the electrical contacts are applied to the conductor bar and the end winding being different from the sites of compression.

17. The method according to claim 16, wherein
the end winding, in particular, comprises an essentially U-shaped end portion with two opposite legs whose inner surfaces facing each other are joined with corresponding lateral surfaces of an end portion of one of the conductor bars.

18. The method according to claim 16, wherein
the step of the integral attachment comprises a pressing operation of the two opposite legs against the respective lateral surfaces of the end portion of the conductor bar.

19. The method according to claim 16, wherein
the power of the pulse is so determined that in the area of the joint essentially no heat is dissipated to the environment.

20. The method according to claim 16, wherein
the two parts are joined to form essentially L-shaped components, with a ceramic or enamel coating being applied prior to or following the joining step, then subsequently being inserted layer by layer into the grooves of the soft magnetic body, and then combined to the respective windings.
